(19) United States
(12) Patent Application Publication
(10) Pub. No.: US 2023/0149890 A1
(43) Pub. Date: May 18, 2023

(54) REACTOR WITH ELECTRICALLY HEATED STRUCTURED CERAMIC CATALYST

(71) Applicant: Gianluca PAULETTO, Freising (DE)

(72) Inventor: Gianluca PAULETTO, Freising (DE)

(21) Appl. No.: 17/919,560

(22) PCT Filed: Apr. 14, 2021
(86) PCT No.: PCT/EP2021/059681

§ 371 Date: Oct. 18, 2022

(30) Foreign Application Priority Data
Apr. 18, 2020 (WO) 20170265.1

(51) Int. Cl. B01J 19/24; B01J 19/08; C01B 3/38

(52) U.S. Cl. CPC B01J 19/2485; B01J 19/087; C01B 3/38; B01J 2219/00135; B01J 2219/2412; B01J 2219/2419; B01J 2219/2438

(57) ABSTRACT

A reactor shell for producing hydrogen and/or synthesis gas and/or carbon dioxide from a fed reactive mixture stream is provided. The reactor shell includes: at least one reactive stream duct formed within the reactor shell, at least one structured ceramic catalyst having a plurality of juxtaposed hollow ceramic subunits, and at least one electrical heating means for heating the structured ceramic catalyst up to a predetermined reaction temperature. The reactor shell is characterized by an electrically heated structured ceramic catalyst. The electrical heating means is arranged inside at least some of the hollow ceramic subunits in a manner that there still remains a flowing passage.

### TECHNICAL FIELD

The invention relates to a reactor shell for producing hydrogen and/or synthesis gas and/or carbon dioxide from a fed reactive mixture stream and particularly to a reactor shell having an electrically heated structured ceramic catalyst. The invention is also related to a relevant method where the structured ceramic catalyst is electrically heated using resistive heating.

### BACKGROUND OF THE INVENTION

Currently stranded gas is often flared for all the cases where the amount is not enough to meet economic conditions. These releases in remote locations make uneconomical the transportation via truck or pipeline. Transformation of this natural gas into product (as methanol, diesel, gasoline, solvents, and other hydrocarbons) is a necessary opportunity to decrease the CO₂ emission. All the processes, used for the production of the above mentioned liquids, involve a first step where the methane-containing gas is, after treatments, converted into synthesis gas.

On the other hand, there is an increasing necessity of hydrogen production plants that convert ammonia, liquid hydrocarbons, as well as biomass based products as methanol, ethanol, and biogas or other methane-containing gas. Accordingly, there is a strong demand for small and distributed plants to produce hydrogen in addition to big centralized plants as this will improve and facilitate the supply chain that would otherwise relies on big production facilities followed by hydrogen transportation as liquefied or pressurized gas. If this is achieved, the widespread availability of this fuel on the territory would not only be a benefit for the fuel cells based applications but also for all the other cases where hydrogen could be used as green fuel and/or reagent and/or raw material and/or energy carriers.

In addition to above, there is also an increasing necessity of removing any polluting substances, responsible of the tropospheric ozone levels, coming from anthropogenic industrial activities. Countries' environmental regulations is constantly becoming stricter in respect to the emissions of volatile organic components (VOC), here identified according to the European Union VOC definition. The necessity of removing VOC until concentrations, often lower than ppm (part per million), not only requires traditional oxidizing flames or temperatures higher than auto-ignition but also catalysts that operate at temperature higher than 200° C. To reach auto-sustainable flames and/or required reaction temperatures, often additional fuel is used that finally contributes in increasing the amount of CO₂ emitted. In some application electricity is also used to reach auto-ignition temperature as reported in US 2014/0283812 A1.

During 2018, more than 70 million tonnes of H₂ were produced and used mainly in ammonia production, refining processes, and methanol production. Different estimations see a rapid and steep increasing hydrogen demand that would double within the next 10 years.

Currently more than 80% of the available H₂, is produced reacting natural gas and/or light naphtha with steam through the steam reforming (SR) reaction (i). This reaction is highly endothermic and therefore approximately 20% of the reacting natural gas is fired in the reformer, together with the fuel gas coming from the pressure swing adsorption (PSA), to maintain the temperature at about 900° C. The remaining part is mostly produced via non-catalytic partial oxidation (PO) that, even if it involves an exothermic reaction (ii), requires complicated and expensive plants and temperatures higher than 1200° C.

CH₄+H₂O CO+3H₂ (i)

CH₄+½O₂ CO+2H₂ (ii)

CH₄+CO₂ 2CO+₂H₂ (iii)

Other than SR and PO a common technology to produce synthesis gas is auto thermal reforming (ATR) that requires big and expensive gas pre-heating ovens, pure oxygen, and highly desulphurized reagents. The final product of ATR is synthesis gas, mainly used in methanol and Fisher Tropsch synthesis.

When H₂ is the desired final product only SR and PO are used and, in both cases, the produced synthesis gas further reacts following the water gas shift reaction (WGS) (iv).

CO+H₂O CO₂+H₂ (iv)

Even if the fired reformer has energy efficiency close to 50%, the SR process has overall energy efficiency higher than 90% coming from the high heat recovery possible from economy of scale. The heat necessary to compensate the reaction endothermicity is produced burning methane and other fuels releasing approximately 3% of the World's emitted CO₂. Reformer tubes are immersed inside the fired reformer, in proximity to the burners. Inside the reformer tubes a nickel based catalyst supported on ceramic materials is used. The diameter of the tubes varies from 100 mm to 150 mm to limit temperature gradients within the reformer tubes, due to temperatures higher than 900° C., low catalyst thermal conductivity, and strongly endothermic SR reaction. The optimized diameter of the reformer tubes maintains strong temperature gradients that result in catalyst effectiveness factor typically lower than 10% requiring hundreds of reformer tubes, filled with catalyst, with length from 10 m to 13 m. The downstream WGS step involves the exothermic WGS reaction. The WGS process requires temperature from 150° C. to 400° C. depending on the catalyst.

Current technologies for producing hydrogen from liquid reagents and methane-containing gas as two step processes have low flexibility with respect to reagents composition and production capacities. The current processes are capital intensive and when economy of scale heat recovery is not possible they achieve energy efficiency lower than 60%. Together with the extra heat exchanger, boiler, reactor, piping, valves, flow meter, fitting and vessel are also required. Moreover, the complex and tailored design of the plant together with the start-up operations decrease the process flexibility.

There have been various attempts to solve the above mentioned problems. For instance, US2013/0028815 A1 and EP3574991A1 disclose applications of electrified metal catalyst supports. However, insufficient surface area and poor support-active phase interaction result in inadequate catalyst stability. Moreover, the resulting macroscopic structures have considerable cross surfaces that decrease electric resistance thus requiring high electric current that complicated the design. For these reasons no commercial gas flow heater, for temperatures higher than 600° C., uses electrified macroscopic structures made of metals. More details on the usage of structured metal catalysts for hight temperature reactions can also be found in the “FeCrAl as a Catalyst Support” article written by Pauletto Gianluca et al. and published by Chemical Reviews 2020, 120, 15, p. 7516-7550.

In addition to above, comprehensive information as regards synthesis gas production can also be found in the “Concepts in Syngas Manufacture” book written by Jens Rostrup—Nielsen and Lars J. Christiansen.

In the last years cracking of renewable ammonia into hydrogen has become an interesting production pathway to supply renewable hydrogen. In particular renewable ammonia is used as an energy carrier that is produced in locations with high availability of renewable energy. Here energy is economically harvested and transformed into chemicals that have high energy density and that can be easily transported as liquid. After transportation the high added value renewable ammonia is converted into renewable hydrogen using a catalytic thermochemical process (above 500° C.): ammonia cracking. Efficient, compact, corrosion resistant, and inexpensive modules are required to enable the transformation of renewable ammonia into hydrogen for fuel cell applications. In particular, an electrified ammonia cracker minimizes operating cost because it avoids consumption of high added value renewable ammonia for generation of heat via combustion in a low efficiency fired furnace.

### BRIEF SUMMARY OF THE INVENTION

In view of the above mentioned technical problems encountered in the prior art, one object of the present invention is to reduce investment costs, number of equipment, energy consumption, carbon dioxide emissions, and dimensions of reactors used for producing hydrogen, synthesis gas, or carbon dioxide.

Another object of the present invention is to provide a reactor, which is used for producing hydrogen, synthesis gas, or carbon dioxide, with wider flexibility both with respect to product capacity and to the possibility of being fed with various reactive mixture streams, even containing relevant amount of carbon dioxide, sulphurated or nitrogenous compounds.

Another object of the present invention is to provide a reactor that is electrically heated using resistive heating elements that are in direct contact with the reactive mixture steam and that can operate at temperature above 1000° C. minimizing the temperature difference between heating elements, structured ceramic catalyst, and reactive mixture stream.

In order to achieve above mentioned objects or those disclosed or to be deducted from the detailed description, the present invention relates to a reactor shell for producing hydrogen and/or synthesis gas and/or carbon dioxide from a fed reactive mixture stream comprising:
at least one reactive stream duct formed within said reactor shell and essentially having at least one reactive stream inlet where said reactive mixture stream is fed, a reactive stream outlet where the reactive mixture stream exits the reactor shell and at least one catalyst section provided between said reactive stream inlet and reactive stream outlet
an insulation filling at least partly encompassing said reactive stream duct,
at least one structured ceramic catalyst accommodated in said catalyst section and having a plurality of juxtaposed hollow ceramic subunits which are configured to allow the reactive mixture stream to pass therethrough,
at least one resistive electrical heating means, being meandered, connected by at least two electrical feeds to an electrical power supply for heating said structured ceramic catalyst up to a predetermined reaction temperature,
wherein said electrical heating means is arranged inside at least some of said hollow ceramic subunits in a manner that there still remains a flowing passage inside the hollow ceramic subunits.

In a probable embodiment of the reactor shell, the electrical heating means comprises meandered sections so that it extends in a meandered manner along within the structured ceramic catalyst (30) that is a bundle formed by the hollow ceramic subunits (31).

In another probable embodiment of the reactor shell, the ceramic subunits are ceramic tubes.

In another probable embodiment of the reactor shell, said resistive heating element is preferably a resistive wire.

In another probable embodiment of the reactor shell, the electrical heating means and electrical 30 power supply are configured to heat the structured ceramic catalyst up to a temperature between 300 and 1300° C.

In another probable embodiment of the reactor shell, the hollow ceramic subunits have longitudinal channels

In another probable embodiment of the reactor shell, the reactive stream duct further comprises a preheating/mixing section, which is formed in the continuation of the reactive stream inlet for preheating/mixing of the reactive mixture stream, a reactive stream channel connecting said preheating/mixing section to the catalyst section and a cooling section, which is formed in the continuation of the catalyst section, for cooling the exiting reactive stream before it exits from the reactive stream outlet.

In another probable embodiment of the reactor shell, this has a design pressure between 1 bar to 150 bar.

The present invention also relates to a method for producing hydrogen and/or synthesis gas and/or carbon dioxide from a fed reactive mixture stream by a catalytic reaction selected from the group consisting of ammonia cracking, steam reforming, dry reforming, partial oxidation, reverse water gas shift, VOC oxidation reactions, and combinations thereof in a reactor shell comprising at least one reactive stream duct essentially having at least one reactive stream inlet, one reactive stream outlet and at least one catalyst section provided between said reactive stream inlet and reactive stream outlet, an insulation filling at least partly encompassing said reactive stream duct, at least one structured ceramic catalyst accommodated in said catalyst section and having a plurality of hollow ceramic subunits which are configured to allow the reactive mixture stream to pass therethrough, at least one resistive electrical heating means, powered by at least two electrical feeds connected to an electrical power supply, for heating said structured ceramic catalyst up to a predetermined reaction temperature. Said method comprises the steps of:
arranging said electrical heating means inside at least some of said hollow ceramic subunits in a manner that a flowing passage inside the hollow ceramic subunits still remains
energizing the electrical heating means via an electric power supply so that the structured ceramic catalyst is heated up to a temperature between 300° C. and 1300° C.
feeding reactive mixture stream with a pressure preferably between 1 bar to 150 bar to the reactor shell through said reactive stream inlet
allowing the reactive mixture stream to pass through said hollow ceramic subunits in a manner that the reactive mixture stream contacts the electrical heating means
allowing the reactive mixture stream to exit from said reactive stream outlet

In a probable application of the method, the electrical heating means are meandered along the structured ceramic catalyst.

In another probable application of the method, the reactive stream fed through the reactive stream inlet is preheated up to a temperatures from 500 to 600° C. at a pressure ranging from 1 bar to 150 bar and gets into a preheating/mixing section of the reactive stream duct before reaching the structured ceramic catalyst.

In another probable application of the method, the reactive stream exiting from the structured ceramic catalyst is cooled down to a temperature from 150° C. to 800° C. in a cooling section of the reactive stream duct prior to exiting from the reactive mixture outlet.

In another probable application of the method, the reactive mixture stream is preheated with the heat of the cooling section via heat exchange means provided therebetween or via additional electrical heating means provided inside or in the vicinity of the preheating/mixing section.

In another probable application of the method, the reaction type for hydrogen and/or synthesis gas and/or carbon dioxide production is selected from the group consisting of ammonia cracking, steam reforming, dry reforming, partial oxidation, reverse water gas shift, VOC oxidation reactions and combinations thereof.

### REFERENCE NUMERALS

10 Reactor shell
11 Insulation filling
20 Reactive stream duct
21 Reactive mixture inlet
22 Preheating/mixing section
23 Reactive stream channel
24 Catalyst section
25 Cooling section
26 Reactive mixture outlet
30 Structured ceramic catalyst
31 Hollow ceramic subunit
311 Subunit inlet
312 Subunit outlet
313 Flowing passage
40 Electrical heating means
41 Meandered section
50 Electrical power supply
51 Electrical feeds
60 Heat exchange means

### BRIEF DESCRIPTION OF FIGURES

FIG. 1 illustrates a vertical cross section of a reactor shell.

FIG. 2 illustrates a horizontal cross section of a reactor shell.

FIG. 3 illustrates a vertical cross section of a structured ceramic catalyst used in the reactor shell.

FIG. 4 illustrates an alternative embodiment of a reactive stream duct formed in the reactor shell.

### DETAILED DESCRIPTION OF THE INVENTION

Preferred embodiments of the present invention will now be more particularly described by way of non-limiting examples with reference to the accompanying drawings.

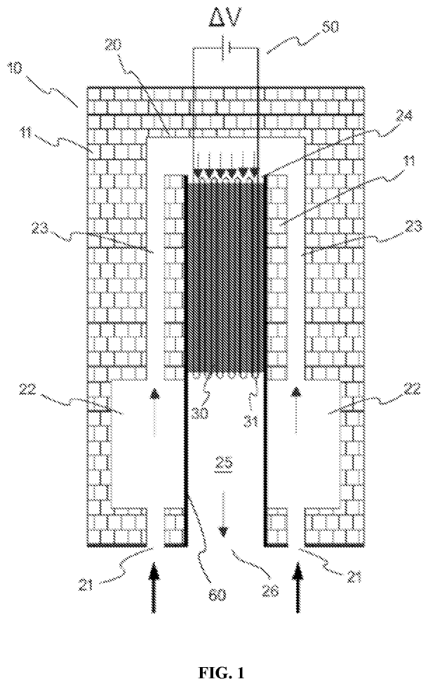

In FIG. 1, a shell (10) of a reactor for the production of hydrogen and/or synthesis gas and/or carbon dioxide from a fed reaction stream, i.e. a reactive mixture stream, is shown. Said reactor shell (10) with an insulation filling (11) mainly comprises a reactive mixture duct (20), which is formed within the reactor shell so as to be encompassed by said insulation filling (11), and a structured ceramic catalyst (30) formed by a multiplicity of juxtaposed hollow ceramic subunits (31) which is arranged within said reactive mixture duct (20) for realizing the ammonia cracking and/or steam reforming and/or dry reforming and/or partial oxidation and/or reverse water gas shift and/or VOC oxidation within the reactor shell. The structured ceramic catalyst (30) is a bundle of juxtaposed hollow ceramic subunits (31) that are equipped with an electrical heating means (40), which is powered through at least two electrical feeds (51) that are running through the reactor shell (10) in an insulated manner from the reactor shell (10). Said electrical feeds (51) are connected to an electrical power supply (50) which is preferably placed outside the reactor shell (10) and configured to heat the structured ceramic catalyst (30) up to a desired temperature so that the intended reaction takes place. Thanks to this arrangement, the reactive mixture stream flows through the reactive mixture duct (20) and exits therefrom after being reacted by said structured ceramic catalyst (30). The structural and process details will hereunder be explained in detail.

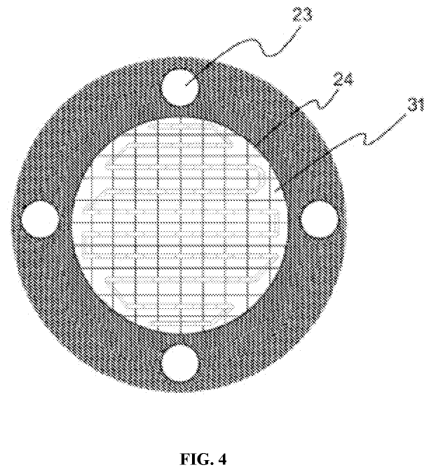

The reactive stream duct (20) comprises, in downstream order, a reactive stream inlet (21), preheating/mixing section (22), reactive stream channel (23), catalyst section (24), cooling section (25) and reactive stream outlet (26). Said structured ceramic catalyst (30) is arranged within said catalyst section (24). On the other hand, as shown in FIG. 1, in a preferred embodiment of the invention there is provided a heat exchange means (60) between the preheating/mixing section (22) and cooling section (25) to adequately transfer the heat of the exiting reactive mixture stream in the cooling section (25) to preheating/mixing section (22). The structural details of the reactive stream such as cross section, size or advancing path may change depending on design requirements of specific applications. For instance, as shown in FIG. 4, the reactive stream duct (20) may comprise four separate reactive stream inlets.

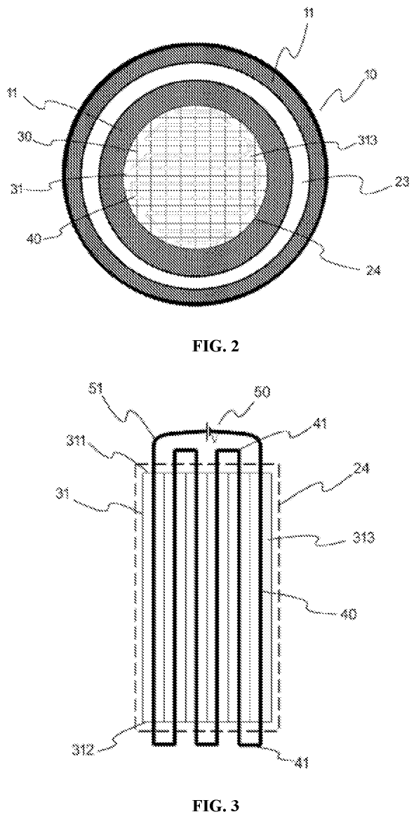

Referring to FIGS. 1 and 2, the structured ceramic catalyst (30) is a “structured catalytic bed” formed by a multiplicity of juxtaposed hollow ceramic subunits (31) that creates a bundle where the reaction takes place. Each hollow ceramic subunit (31) of the structured ceramic catalyst (30) has a flowing passage (313) that allows the reactive mixture stream to pass therethrough. The structured ceramic catalyst (30) can be formed by a multiplicity of tubes, pellets, foams, monoliths or other hollow ceramic shapes that are juxtaposed to form a bundle. Accordingly, form and deployment of the hollow ceramic subunits (31) define the structure of the structured ceramic catalyst (30). The material of the hollow ceramic subunits (31) is selected from the group consisting of SiO₂, Al₂O₃, Y₂O₃, WO₃, ZrO₂, TiO₂, MgO, CaO, CeO₂, FeO₂, ZnO₂ and combinations thereof supporting a catalytically active material as for example Pt, Ru, Rh, Ir, Pd or Ni.

Additionally, in alternative embodiments, the reactor shell (10) may include more than one structured ceramic catalysts which are connected to each other in serial or parallel and/or have the same or different specifications.

Among the different structured ceramic catalyst (30) that can be used to operate under these reaction conditions, ceramic materials will be used since metallic supports, even if they usually present good thermal properties, they could short the electrical heating means (40) causing poor and/or inhomogeneous heating, decreasing the lifetime of the electrical heating means (40). The catalytically active species supported on the structured ceramic catalyst (30) are transition metals of the groups IIIB to IIB (d-block elements) and/or combination of two or more active species possibly including alkali metals. The structured ceramic catalyst (30) will undergo heterogeneous catalyst preparation as incipient wetness impregnation and/or impregnation and/or support wash coating and/or in-situ synthesis that are traditionally used in the synthesis of heterogeneous catalysts. The structured ceramic catalyst (30) is arranged in a way that the fed reactive mixture stream can have a contact time from 0.1 ms to 30000 ms. Related to this, contact time is obtained dividing volume of the structured ceramic catalyst by volumetric flow rate of the reactive stream.

As shown in FIGS. 2 and 3, the electrical heating means (40) of the invention is arranged within the hollow ceramic subunits (31) so that the structured ceramic catalyst (30) is heated from inside. In detail, in a preferred embodiment of the invention, the electrical heating means (40) is meandered through some or all of the plurality of hollow ceramic subunits (31). Thanks to this embodiment, the hollow ceramic subunits (31) are heated up by the electrical heating means (40) so that the structured ceramic catalyst (30) is heated from inside. The physical proximity (or contact) of the electrical heating means (40) with the structured ceramic catalyst (30) and the direct contact with the reactive mixture stream enhances the heat transfer via irradiation, convection, and conduction. The proximity will make possible to operate the structured ceramic catalyst (30) at temperature between 300° C. to 1300° C. Related to this, the combination of the structured ceramic catalyst (30) and the electrical heating means (40) must be arranged in a way to minimize the pressure drop while maintaining high heat and mass transfer that is affected by the dimension of the flowing passage (313). For instance, it is preferred that electrical heating means (40) is sized to leave an adequate flowing passage (313) inside the hollow ceramic subunits (31) so that the flow of the reactive mixture stream is minimally affected while maintaining proximity to the structured ceramic catalyst (30), i.e. to inner walls of the hollow ceramic subunits (31). Accordingly, in a preferred embodiment, the electrical heating means (40) is a resistive wire with enough flexibility so that it results meandered after bundling the hollow ceramic subunits (31) (31) up. The temperature difference between the electrical heating means (40) and heated reactive mixture stream is minimized as the reactive mixture stream is confined within a small gap created by the electrical heating means (40) and the hollow ceramic subunits (31). This has a direct impact on the radial temperature gradient thus on the carbon forming potential that, in the case of reforming reactions, depends upon the temperatures of the hot surfaces (electrical heating means (40) and structured ceramic catalyst (30)) vs. the temperature of reactive mixture stream. The hot surfaces, the electrical heating means (40), and the structured ceramic catalyst (30), are in proximity to each other, have high view factor, and are in direct contact with the reacting mixture stream.

The resistance of the electrical heating means (40) is achieved using a minimized number of wires that result meandered within the structured ceramic catalyst (30) formed as a bundle of hollow ceramic subunits (31). The electrical heating means (40) are resistive heating wires having considerable diameters, preferably above 2 mm, thus able to operate at temperatures above 1000° C. Following to the second Ohm's Law, the electrical resistance of the heating means (40) is achieved using long meandered wires rather than short and small diameter wires or filaments.

Thanks to the arrangement of the electrical heating means (40) within the hollow structured ceramic catalyst (30), the resistive heating wires benefit of the mechanical support and geometrical confinement provided by the hollow ceramic subunits (31). Thanks to this configuration, to the extraordinary high stability of longitudinally shaped resistive heating wires and in particular to the presence of materials that show catalytic effects the maximum power of the electrical heating means (40) is drastically increased compared to any other apparatus that has been disclosed. The surface load is not limited by electromagnetic forces, thermal expansion or lower physical properties induced by the extremely high operating temperatures up to 1300° C.

If the electrical heating means (40) were embedded within the bulk of the structured ceramic catalyst (30), the high operating temperatures, often above 1000° C., would induce mechanical stresses as consequence of the mismatch between the thermal expansion coefficients of the electrical heating means (40) and the ceramic catalyst (30). As consequence the ceramic supported catalyst (30) would crack and fail.

Additionally, since the electrical heating means (40) are meandered through some or all of the plurality of hollow ceramic subunits (31), there is no need to connect the electrical heating means (40) to each others with a connector element which will cause: inhomogeneities and irregularities of the electrical heating means (40) in particular near potential welding, reduction of the electrical resistance as consequence of the in parallel connection of multiple electrical heat means (40), additional workload and complexity of manufacturing.

On the other hand, the deployment of the electrical heating means (40) within the structured ceramic catalyst (30) is imposed by the selected type and geometrical properties of the hollow ceramic subunits (31) such as tubes, pellets, foams, monoliths or other hollow ceramic shapes.

For instance, as shown in FIG. 3, the structured ceramic catalyst is a bundle of hollow ceramic tubes that are juxtaposed defining a grid like cross section. Thanks to this juxtaposed arrangement, the flow of the reactive mixture stream is confined inside the flowing passage (313) where the electrical heating means (40) is located. If the hollow ceramic subunits (31) create a bundle in a not juxtaposed manner, bypass may occur in regions left between the neighboring hollow ceramic subunits (31). Since said bypass regions are outside of the flowing passages (313) thus not in direct contact with the electrical heating means (40) and the internal surface of the hollow ceramic subunits (31), the temperature of the reactive mixture stream decreases, resulting in a lower efficiency of the reactor. Thus, if monolithic type of structured ceramic catalyst is formed in the reactor shell (10), the electrical heating means (40) is placed longitudinally within the hollow ceramic subunits (31), extending in parallel to the flow direction of the reactive mixture stream while the meandered sections (41) of the electrical heating means (20) remain outside the hollow ceramic subunits (31). After forming the bundle of the hollow ceramic subunits (31) with the installed electrical heating means (40) it results that in the structured ceramic catalyst (30), the resistive wire is inserted from a subunit inlet (311) of a first hollow ceramic subunit (31) and exited from a subunit outlet (312) thereof at the other end and then inserted to a subunit outlet of a second hollow ceramic subunit (31) and exited from a subunit inlet thereof, as shown in FIGS. 1, 2 and 3.

If, foam type, i.e. open cell form type, as hollow ceramic subunits (31) are selected for the structured ceramic catalyst, the electrical heating means (40) may extend omnidirectional similar to the hollow ceramic subunits (31) defined by the foamy structure. In detail, the electrical heating means (40) is passed through the open cells, defining the flowing passages (313), of the structured ceramic catalyst (30) from its inlet to the outlet opening, creating a heating passage along the placement of the electrical heating means (40). In this case, the reactive mixture strem flows omnidirectional due to the omnidirectional open structure of the open cell foam of the structured ceramic catalyst (30). The meandering of the electrical heating means is done in a similar way to the previously described embodiment.

Preferably, the electrical heating means (40) comprises a resistive heating element in a wire form. Thanks to the dimensions and the geometrical configuration of said wire together with its proximity to a catalytically active material, this can withstand temperature up to 1400° C. but can also be meandered.

In the light of the above mentioned structural properties of the invention, it is explained below in details how the reaction progresses.

Once a reactive mixture stream is fed through the reactive stream inlet (21), the vaporization and/or atomization/nebulization of one or more streams of liquid reagent consisting of one or more of the following reagents occur: ammonia, naphtha, alcohols, water, other products of refining, a methane-containing stream, a gaseous stream with VOC and, an oxidizing stream. The fed liquid and/or gaseous reagents (i.e. reactive mixture stream) are possibly nebulized and/or atomized and/or vaporized using a vapour and/or gaseous stream possibly assisted by ultrasounds and where oxidizing streams of vapour and/or air and/or oxygen and/or carbon dioxide are also fed.

Said reactive mixture stream fed to the reactive mixture inlet (21) is possibly pre-heated at a temperature lower than the boiling point, thus the evaporation, located inside the reactor shell, will be used to cool down the reaction products and will help the control of the temperature. Said reactive mixture stream fed to the reactive mixture inlet (21) has a temperature ranging from 25° C. to 600° C., preferably at a temperature lower than 200° C. and at a pressure ranging from 1 bar to 150 bar, preferably lower than 50 bar.

The vaporization and/or atomization/nebulization, that the reactive mixture stream undergoes (e.g. by ultrasound) before being fed into the reactive stream inlet (21), must ensure an optimized phase change of the liquid stream and avoid gas phase reaction. The poor evaporation and mixing must be avoided as:
They could cause the formation of carbonaceous deposit,
They could create cold spot and/or hot spot that could damage the reactor shell including structured ceramic catalyst,
They could create flammable pockets within the reactor shell with possible safety issues,
They could decrease the yield of the reaction toward the desired products,
They could require additional and extra consumption of energy in the structured ceramic catalyst (30),

In various embodiments of the reactor, the feed of the reactive mixture stream in liquid form can take place in a single or multiple points and/or position in the apparatus. The expansion and nebulization can be improved by optimized design of the reactive stream duct (20) geometry and/or using high surface area material with high thermal properties (thermal conductivity higher than 10 W m⁻¹° C.⁻¹).

In the preheating/mixing section (22) which begins at the end of the reactive stream inlet (21) and ends at the inlet of the reactive stream channel (23), the preheating and mixing of the fed reactive mixture stream is realized. In this section, reactive mixture stream, which is in nebulized, vaporized or atomized form, coming from the reactive stream inlet (21) is heated at temperatures varying from 50° C. to 600° C. and at a pressure ranging from 1 bar to 150 bar with the formation of a possible biphasic liquid-gas reaction mixture, and gets mixed.

In a preferred embodiment, an additional electrical heating means is provided in the preheating/mixing section (22) for heating the reactive stream.

In another preferred embodiment, the heat in the cooling section (25) is transferred to the preheating/mixing section (22) via heat exchange means (60) provided between the preheating/mixing section (22) and the cooling section (25). For instance, additional heating is provided by the additional exothermic (giving out heat) reactions such as WGS at a temperature from 150° C. to 400° C., happening at the reactive mixture outlet (26), of which the heat is transferred into the preheating/mixing section (22) through a heat exchange means (60), such as a thermally conductive wall, arranged between the preheating/mixing section (22) and reactive mixture outlet (26).

In the preheating/mixing section (22), the reactive mixture stream is also homogenized by being mixed before going into the reactive stream channel (23). The purpose of the mixing function is to homogenize and to increase the temperature of the reactive mixture stream before entering the structured ceramic catalyst (30).

The preheating/mixing section (22) can have all different geometrical shapes including hemispherical and paraboloid. This zone could be either empty and/or filled with a solid to create a random or structured matrix that improves the mixing and the heat transfer as well as decreases the size. The transport phenomena could therefore rely on different transport phenomena according to the different design of this section. The design of the preheating/mixing section (22) must also avoid the presence of cold surfaces that could result on deposition of liquid reagent and/or poor cooling of the hot stream affecting the mechanical stability of the reactor and possibly the water-gas shift equilibrium. Moreover, when the fed reactive mixture stream is within the flammable limits given the composition, temperature, and pressure, the linear rate of the reactive mixture stream must be higher than the flame rate.

Subsequently, the preheated and mixed reactive stream travels into the reactive stream channel (23), where minimized heat transfer occurs due to the insulation filling (11) covering the channel.

Afterwards the reactive mixture stream passes to structured ceramic catalyst (30) which is arranged inside the catalyst section (24). In the structured ceramic catalyst, the reactive mixture stream undergoes a catalytic reaction such as ammonia cracking and/or SR and/or DR and/or PO and/or reverse WGS and/or VOC oxidation by coming in physical contact with the walls of the hollow ceramic subunits (31) of the structured ceramic catalyst (30) that support catalytically active materials. The hollow ceramic subunits (31) are configured to prevent any stream bypass therebetween. In other words, the entire reactive mixture stream flowing through the structured ceramic catalyst (30) flows through the plurality of flowing passages (313) getting in direct contact with the electric heating means (40) and the catalytically active material. The catalytic reaction is realized when the structured ceramic catalyst (30) is heated from 300° C. to 1300° C.

The required heat is provided by the meandered electrical heating means (40) along some or all of the hollow ceramic subunits (31) as explained above so that the structured ceramic catalyst (30) is heated in an effective manner. Thanks to this arrangement, the reactive mixture stream passing through the structured ceramic catalyst (30) will not only increase in temperature but will also react on the surface of the structured ceramic catalyst (30) that is efficiently and homogeneously heated, minimizing any temperature gradients that could result into carbonaceous deposits and/or thermal effect on the reaction and/or low catalyst effectiveness factor. Moreover, the temperature that is reached within the structured ceramic catalyst (30), often above 1000° C., will increase reaction rate that, requiring reduced contact times, will result in compact and small reactors.

The final reaction products will comprise a mixture of hydrogen and/or synthesis gas and/or CO₂ depending on the feed composition and on the reactions taking place. At the end of the ammonia cracking and/or SR and/or DR and/or PO and/or reverse WGS and/or full oxidation the reaction mixture will have a temperature from 300° C. to 1300° C., preferably around 1000° C.

The further advantages of equipping the structured ceramic catalyst (30) with meandered electrical heating means (40) in the invented way, as explained above, are as follows:
the possibility of limiting secondary reactions,
the fast start up,
the in-situ generation of heat that prevents heat transfer between different environments and/or flames at high temperature and/or across surfaces,
the possibility of keeping low surface temperature of the resistive heating element using the endothermic reaction as an energy sink that increases the lifetime of the resistive heating element,
the possibility of using a meandered electrical heating means (40) made of resistive wires that can operates at temperature of 1300° C. in a structured ceramic catalyst formed by bundling hollow ceramic subunits up,
the possibility to avoid connector elements for the resistive wires thus required welding or other connections that introduce local inhomogeneities of the electrical heating means (40) that would result in local hot spots and consequent fail of the electrical heating means (40),
the possibility to easily increase the power duty according to the difference in the fed reactive mixture stream composition,
the tight temperature control that will also facilitate and make up for possible variation in the apparatus capacity,
the fact that the electrical resistance of the used electrical heating means (40) requires standard operating voltage and current, nowadays used in resistive heaters, avoiding complicated electrical delivery systems required in the case of electrified macroscopic structure of electrically conductive materials as in the case of NiCr or FeCrAl alloys or SiC,
the possibility of homogeneously reaching high temperature within the structured ceramic catalyst (30) that will decrease the energy consumption as the minimized possibility of having cold and/or hot surfaces decreases the amount of oxidizing co-reactant required to prevent any catalyst deactivation, for example by carbon deposition,
the possibility to maximize product selectivity after minimizing the amount of oxidizing co-reactant present during reforming reactions,
the possibility to increase operating temperature thus conversion of reagents in endothermic reactions without being limited by the maximum operating temperature of the surfaces that provide physical confinements as in the case of reforming tubes located inside the firebox,
the minimized carbon forming potential as consequence of minimized radial temperature gradient within the structured ceramic catalyst (30),
the possibility of reaching temperature as high as 1400° C., also in cycling conditions, that can be used for the catalyst activation and/or regeneration from possible carbonaceous deposit and/or poisoning species as sulphur and/or very high boiling point compounds.

The reactive mixture stream exiting the structured ceramic catalyst (30) arranged in the catalyst section (24) undergoes cooling at the cooling section (25), where the heat is exchanged with the preheating/mixing section (22) through the wall in between as explained above. This section is used for the exchange of heat between the reactive mixture stream leaving the catalyst section (24) and the reactive mixture stream present in the preheating/mixing section (22). This section will involve transfer between gases and/or a gas-liquid possibly involving phase transition maximizing the amount of heat that can be removed. The gas phase leaving the catalyst section (24) and entering the cooling section (25) flows in a zone that can have any geometrical shapes/configuration and possibly contains a highly conductive structured or/random packing material enhancing the turbulence at the heat transfer interface and/or the radial thermal conduction. The fast cooling step, relying on the high heat transfer coming from boiling liquids and strong temperature gradient, will minimize the cooling time therefore avoiding any undesired reaction as methanation and carbon monoxide disproportion.

In a preferred embodiment, gas quenching with water or steam might also be used for the further cooling of the reactive mixture stream exiting the catalyst section (24). The counter-flow heat exchange occurring between the preheating/mixing section (22) and the cooling section (25) will improve the heat transfer. Energy transfer between product and reactive streams will take place in the same equipment thus intensifying the process and decreasing the capital investment costs avoiding extra heat exchanger, piping, valves, flow meter, fitting and vessel. In a preferred embodiment, after the decrease of the temperature within the cooling section (25), a system capable of promoting the exothermic WGS reaction at a temperature from 150° C. to 400° C. can also be used, providing extra heating assistance to the preheating/mixture section (22).

Finally, the reactive mixture stream arrives at the reactive stream outlet (26) before leaving the reactor shell (10).

By means of the above explained system and process with respect to ammonia cracking and/or SR and/or DR and/or PO and/or reverse WGS and/or VOC oxidation reaction, following results can be obtained:
the full removal of CO₂ production coming from fuel gas combustion required for high temperature endothermic reactions,
the possibility of relying on renewable electrical energy and converting this into energy carriers following a thermochemical reaction,
high exergy efficiency,
the possibility of avoiding temperature gradients that would result in low catalyst effectiveness factor and big reactor volume,
the possibility of converting a wide range of reactive mixtures and producing a wide range of synthesis gas compositions,
the possibility of treating and reacting a wide range of reactive mixtures switching the main reaction among SR and/or DR and/or PO and/or reverse WGS and/or full oxidation,
the possibility of industrializing DR reaction and therefore the usage of CO₂ for the final production of synthesis gas and/or hydrogen,
the possibility of avoiding expensive high temperature fired furnaces and downstream tail gas treatments,
the possibility to scale down synthesis gas and/or hydrogen production units until flows that currently do not make the process economical,
the possibility of decreasing the upstream heat exchangers size and/or number and/or avoiding any preheating, not only simplifying the process, but also decreasing the consumption of fuel gas and therefore the CO₂ production,
the possibility of minimizing capital and operational costs intensifying the process, decreasing both volume and number of equipment,
the possibility of adding air and/or oxygen in the reaction thus decreasing the demand of energy that the electrical heating elements must supply,
the possibility of having CO₂ in a gas final stream in absence of inert (as nitrogen) and unreacted gases making possible low cost CO₂ separation for carbon sequestration,
the possibility of removing CO₂ from the atmosphere relying on biomass based reagents followed by downstream CO₂ sequestration,
the possibility of removing VOC impurities without using any additional fuels,
the fast start up time and the flexibility of reacting different compositions and flows of reactive mixture streams that allow to quickly vary the synthesis gas and/or hydrogen production minimizing accumulation and storage of reagents,
the possibility of producing hydrogen and/or synthesis gas using different types of starting reagents, decoupling the process economy from the reagent price assumed during plant design thus making possible to switch to the cheapest reagent while using the same method and apparatus.
the possibility of using very high temperature (higher than 1000° C.) and high pressure with a consequent reduction of the volumes of the equipment further decreasing capital cost, heat losses, safety problems and human footprint.

What is claimed is:

1. A reactor shell for producing hydrogen and/or a synthesis gas and/or carbon dioxide from a fed reactive mixture stream comprising:
at least one reactive stream duct formed within the reactor shell and having at least one reactive stream inlet, a reactive stream outlet, and at least one catalyst section, wherein the fed reactive mixture stream is fed in the at least one reactive stream inlet, the fed reactive mixture stream exits the reactor shell through the reactive stream outlet, and the at least one catalyst section is provided between the at least one reactive stream inlet and the reactive stream outlet,
an insulation filling at least partly encompassing the at least one reactive stream duct,
at least one structured ceramic catalyst accommodated in the at least one catalyst section and having a plurality of juxtaposed hollow ceramic subunits, wherein the plurality of juxtaposed hollow ceramic subunits are configured to allow the fed reactive mixture stream to pass therethrough, and
at least one resistive electrical heating means being meandered and connected by at least two electrical feeds to an electrical power supply for heating the at least one structured ceramic catalyst up to a predetermined reaction temperature,
wherein the at least one resistive electrical heating means is arranged inside at least some of the plurality of juxtaposed hollow ceramic subunits, and wherein a flowing passage remains inside the plurality of juxtaposed hollow ceramic subunits.

2. The reactor shell according to claim 1, wherein the at least one resistive electrical heating means comprises meandered sections, the at least one resistive electrical heating means extends in a meandered manner along within the at least one structured ceramic catalyst, that the at least one structured ceramic catalyst is a bundle formed by the plurality of juxtaposed hollow ceramic subunits.

3. The reactor shell according to claim 1, wherein the plurality of juxtaposed hollow ceramic subunits are ceramic tubes.

4. The reactor shell according to claim 1, wherein the at least one resistive electrical heating means is a resistive wire.

5. The reactor shell according to claim 1, wherein the at least one resistive electrical heating means and the electrical power supply are configured to heat the at least one structured ceramic catalyst up to a temperature between 300° C. and 1300° C.

6. The reactor shell according to claim 1, wherein the plurality of juxtaposed hollow ceramic subunits have longitudinal channels.

7. The reactor shell according to claim 1, wherein the at least one reactive stream duct further comprises a preheating/mixing section, a reactive stream channel, and a cooling section, the preheating/mixing section is formed in a continuation of the at least one reactive stream inlet for preheating/mixing of the fed reactive mixture stream, the reactive stream channel connects the preheating/mixing section to the at least one catalyst section and the cooling section, the cooling section is formed in a continuation of the at least one catalyst section for cooling an exiting reactive stream before the exiting reactive stream exits from the reactive stream outlet.

8. The reactor shell according to claim 1, wherein a design pressure of the reactor shell is between 1 bar to 150 bar.

9. A method for producing hydrogen and/or a synthesis gas and/or carbon dioxide from a fed reactive mixture stream by a catalytic reaction selected from the group consisting of an ammonia cracking, a steam reforming, a dry reforming, a partial oxidation, a reverse water gas shift, VOC oxidation reactions, and combinations of the ammonia cracking, the steam reforming, the dry reforming, the partial oxidation, the reverse water gas shift, and the VOC oxidation reactions in a reactor shell, the reactor shell comprising:
at least one reactive stream duct having at least one reactive stream inlet, a reactive stream outlet, and at least one catalyst section provided between the at least one reactive stream inlet and the reactive stream outlet,
an insulation filling at least partly encompassing the at least one reactive stream duct,
at least one structured ceramic catalyst accommodated in the at least one catalyst section and having a plurality of hollow ceramic subunits, wherein the plurality of hollow ceramic subunits are configured to allow the fed reactive mixture stream to pass therethrough, and
at least one resistive electrical heating means powered by at least two electrical feeds and connected to an electrical power supply, for heating the at least one structured ceramic catalyst up to a predetermined reaction temperature,
the method comprising steps of:
arranging the at least one resistive electrical heating means inside at least some of the plurality of hollow ceramic subunits, so a flowing passage being inside the plurality of hollow ceramic subunits still remains,
energizing the at least one resistive electrical heating means via an electric power supply, so the at least one structured ceramic catalyst is heated up to a first temperature between 300° C. and 1300° C.,
feeding the fed reactive mixture stream with a first pressure between 1 bar to 150 bar to the reactor shell through the at least one reactive stream inlet,
allowing the fed reactive mixture stream to pass through the plurality of hollow ceramic subunits, so the fed reactive mixture stream contacting the at least one resistive electrical heating means, and
allowing the fed reactive mixture stream to exit from the reactive stream outlet.

10. The method according to claim 9, wherein the at least one resistive electrical heating means is meandered along the at least one structured ceramic catalyst.

11. The method according to claim 9, wherein a reactive stream fed through the at least one reactive stream inlet is preheated up to a second temperature from 50° C. to 600° C. at a second pressure ranging from 1 bar to 150 bar and gets into a preheating/mixing section of the at least one reactive stream duct before reaching the at least one structured ceramic catalyst.

12. The method according to claim 9, wherein a reactive stream exiting from the at least one structured ceramic catalyst is cooled down to a second temperature from 150° C. to 800° C. in a cooling section of the at least one reactive stream duct prior to exiting from the reactive mixture outlet.

13. The method according to claim 11, wherein the fed reactive mixture stream is preheated with a heat of a cooling section via a heat exchange means provided between the cooling section and the preheating/mixing section or via an additional electrical heating means provided inside or in a vicinity of the preheating/mixing section.

14. The method according to claim 10, wherein a reaction type for the hydrogen and/or the synthesis gas and/or the carbon dioxide is selected from the group consisting of the ammonia cracking, the steam reforming, the dry reforming, the partial oxidation, the reverse water gas shift, the VOC oxidation reactions, and combinations of the ammonia cracking, the steam reforming, the dry reforming, the partial oxidation, the reverse water gas shift, and the VOC oxidation reactions.

15. The method according to claim 12, wherein the fed reactive mixture stream is preheated with a heat of the cooling section via a heat exchange means provided between the cooling section and the preheating/mixing section or via an additional electrical heating means provided inside or in a vicinity of the preheating/mixing section.

16. The reactor shell according to claim 2, wherein the at least one resistive electrical heating means and the electrical power supply are configured to heat the at least one structured ceramic catalyst up to a temperature between 300° C. and 1300° C.

17. The reactor shell according to claim 3, wherein the at least one resistive electrical heating means and the electrical power supply are configured to heat the at least one structured ceramic catalyst up to a temperature between 300° C. and 1300° C.

18. The reactor shell according to claim 4, wherein the at least one resistive electrical heating means and the electrical power supply are configured to heat the at least one structured ceramic catalyst up to a temperature between 300° C. and 1300° C.

19. The reactor shell according to claim 2, wherein the plurality of juxtaposed hollow ceramic subunits have longitudinal channels.

20. The reactor shell according to claim 3, wherein the plurality of juxtaposed hollow ceramic subunits have longitudinal channels.
